(19) United States
(12) Patent Application Publication
(10) Pub. No.: US 2009/0159861 A1
(43) Pub. Date: Jun. 25, 2009

(54) COMPOUND CURVED CONTACT PAD FOR FORK LIFT JACK

(76) Inventors: Joseph L. Gray, St. Joseph, MO (US); Richard T. Francis, Smithville, MO (US)

Correspondence Address: POLSINELLI SHUGHART PC, 700 West 47th Street, Suite 1000, KANSAS CITY, MO, 64112, US

(21) Appl. No.: 11/959,712

(22) Filed: Dec. 19, 2007

(51) Int. Cl. B66F 5/00

(52) U.S. Cl. 254/131

(57) ABSTRACT

A compound curved or barrel shaped contact pad for a fork lift jack includes a mounting stem diverging into a wedge-shaped contact head having a contact surface thereon for engagement with a member of a vehicle to be lifted. The contact surface has a convex front-to-back curvature and a convex transverse curvature which enable the contact surface to positively engage the vehicle member in a variety of orientations of a lift arm of a jack. The contact surface has a non-slip surface texture, such as a plurality of transversely extending serrations. The contact pad has positioning notches formed into side surfaces for cooperation with structure on the lift arm to enable the contact pad to be selectively placed in a raised deployed position or a lowered stowed position.

### BACKGROUND OF THE INVENTION

The present invention is broadly concerned with lifting devices and, more particularly, with embodiments of a compound curved contact pad for a lifting device such as a fork lift jack.

When lifted from one side or end, certain vehicles or other heavy objects tend to tilt about both their longitudinal and transverse axes. In following this natural rising arc of the vehicle, particularly whenever engaging and lifting the vehicle from its side, a lifting jack will also be subject to a certain amount of horizontal movement in relation to the vehicle. In attempting to compensate for this horizontal movement, there is a tendency for slippage either at the jack's contact with the vehicle or at its contact with the floor support surface. In extreme cases, slippage can cause load loss resulting in danger for both the operator and the machinery being lifted.

Certain types of vehicles, such as forklift trucks, have low ground clearances requiring a jack quite low in profile so that it is capable of sliding underneath the truck to a position engageable with an adequate support point. Yet these trucks are quite heavy and normally require a large, powerful lift. As a result of these and other problems, transportable manual jacks of conventional design have been found to be unsafe and generally unacceptable for use in lifting such vehicles.

A jack which addresses many of these problems is described and illustrated in U.S. Pat. No. 3,780,987, the disclosure of which is incorporated herein by reference. The '987 jack includes a scissors formed by a pair of pivotally connected arms. A lift arm has a contact pad to engage the vehicle to be lifted at an upper end and a wheel at an opposite lower end. A base or support arm has a partially cylindrical base pad at a lower end to engage the ground and has an opposite upper end pivotally connected to a cylinder of a hydraulic actuator which has a piston thereof pivotally connected to the lower end of the lift arm. A hand lever is pivotally connected to the actuator cylinder and has a link connected to a pump piston of a hydraulic pump which forces fluid into a top end of the actuator cylinder in response to use of the hand lever to cause the actuator piston to extend. A suitable valve along with a hydraulic passage having a limited flow rate allow the jack to be lowered in a controlled manner.

The jack is designed to cause the contact pad to follow an arcuate path which approximates the lift point path as one end or side of a fork lift is being raised. The contact pad has a contact surface which is cylindrically curved about a lateral axis and is serrated to help prevent slippage with the engaged vehicle support point. As the actuation piston is extended, the contact pad “rolls” beneath the engaged vehicle member, and the wheel at the opposite end rolls on the floor surface so that the lift pad moves toward the vehicle as it is raised. When one side of a vehicle is raised, the engaged vehicle member pivots in an arc about the wheels on the opposite side of vehicle. The design of components of the '987 jack cause the contact pad to move in a similar arc to follow the motion of the engaged vehicle member while providing a substantially stationary, solid footing for the vehicle and jack during lifting. The upper end of the lift arm has a pair of lift notches for alternative use in engaging a tubular vehicle member or a similarly shaped vehicle member. The '987 contact pad may be selectively placed in one of two positions: a deployed position to engage a vehicle member or in a stowed position for use of the lift notches.

Because the contact surface of the '987 contact pad is substantially cylindrical, a problem occurs if there is a slight angular discrepancy between the engaged vehicle member and the jack. In such a situation, an edge of the contact surface of the pad engages the vehicle member which may generate a less positive grip between the lift pad and the vehicle support point.

### SUMMARY OF THE INVENTION

The present invention provides an improved contact pad structure for jacks intended for low ground clearance vehicles such as fork lift vehicles. The contact pad has a compound curved shape with a non-slip surface texture. An embodiment of the contact pad includes a mounting stem diverging into a substantially wedge shaped contact head having the contact surface thereon. The mounting stem is configured to cooperate with structure on the jack to secure the contact pad thereto. In addition to the lateral curvature, the contact surface has a front-to-back curvature, such that the contact surface has a compound curvature or barrel shape. In an embodiment of the contact pad, the non-slip surface texture includes a plurality of elongated serrations extending transversely across the contact surface from one side surface to an opposite side surface.

The contact pad may cooperate with a lift arm of the jack whereby the contact pad is selectively placed in a deployed position to expose the non-slip contact surface for engagement with a member of a vehicle to be lifted or in a stowed position to allow a notched end of the lift arm to engage a member on the lifted vehicle. For such selective deployment, the contact pad is provided with a mounting bore having an obround cross section and extending through the mounting stem from one side surface to the other. The obround bore receives a mounting pin on the lift arm of the jack and functions as a slot to allow the mounting pad slide in and out relative to the mounting pin. The pad structure is provided with sets of pad positioning notches, including a pair of deployment notches and a pair of stowing notches, formed into the opposite side surfaces. The notches cooperate with pad positioning pegs on the jack lift arm to selectively secure the contact pad structure in either the deployed position or the stowed position. To move the contact pad from the stowed position to the deployed position, the pad is pulled out relative to the mounting pin and pivoted up and lowered to engage the deployment notches with the pad positioning pads. For stowage, the pad is pulled up and pivoted forward to engage the stowing notches with the positioning pegs.

Objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a side elevational view of a fork lift jack in which a compound curved contact pad according to the present invention is installed.

FIG. 2 is an enlarged perspective view of an embodiment of the compound curved contact pad.

FIG. 3 is an enlarged front elevational view of the compound curved contact pad.

FIG. 4 is a fragmentary side elevational view of a portion of a lift arm of the fork lift jack with a wall of the lift arm broken away to show the compound curved contact pad in a raised or deployed position.

FIG. 5 is a view similar to FIG. 4 and illustrates the compound curved contact pad in a lowered or stowed position.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring in detail to the drawing, the reference numeral 1 generally designates an embodiment of a compound curved contact pad structure according to the present invention. The pad structure or pad 1 is installed on a lift device or mechanism 2, such as a fork lift jack. The pad 1 is positioned beneath a member of a vehicle (not shown) to be lifted to provide a non-slip engagement of the jack 2 with the vehicle.

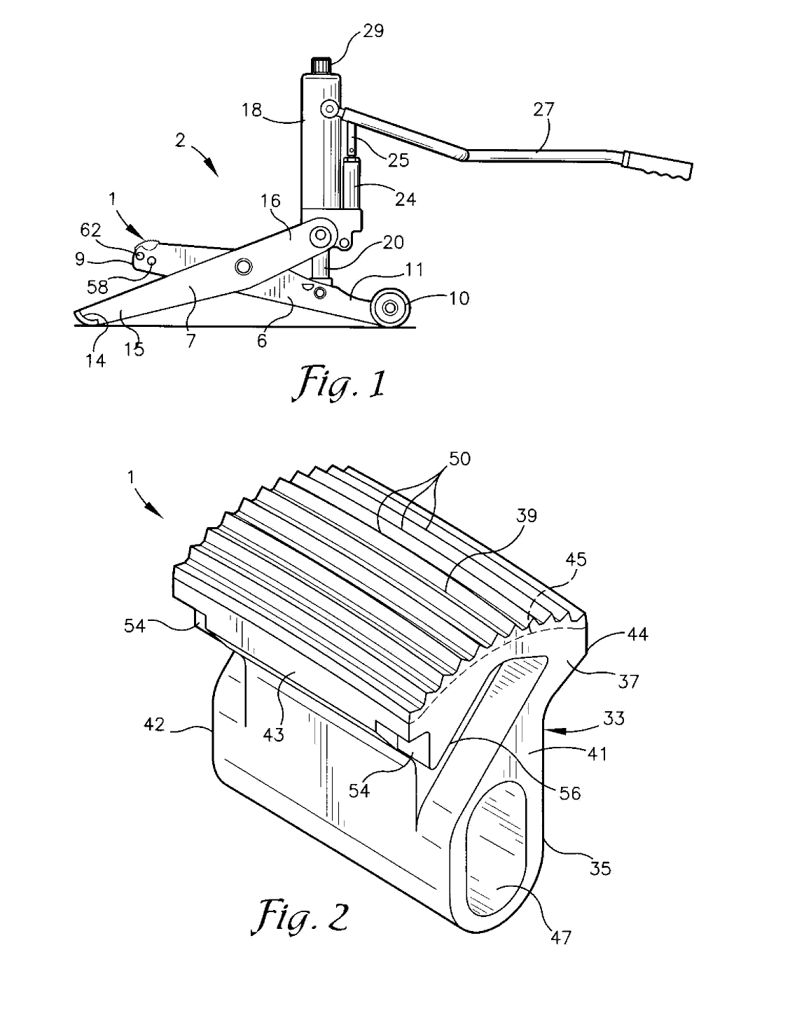

Referring to FIG. 1, an exemplary jack 2 includes a lift arm 6 and a base or support arm 7 which are pivotally connected at central portions thereof to form a scissors arrangement. The arms 6 and 7 may be formed of laterally spaced sets of beam members which are joined by cross members (not shown). The lift arm 6 has the contact pad 1 positioned at an upper end 9 and a pair of ground engagement wheels 10 journaled at a lower end 11. The support arm 7 has a ground contact pad 14 positioned at a lower end 15 and has an upper end 16 pivotally connected to a hydraulic actuator or lift cylinder 18. The cylinder 18 has an outer end of a lift piston rod 20 pivotally connected to the lower end 11 of the lift arm 6. The piston rod 20 is extended from the cylinder 18 by pumping hydraulic fluid into the top of the cylinder 18 above an internal piston (not shown) within the cylinder. This is accomplished by operation of a hydraulic pump mechanism or cylinder 24 in cooperation with a pump piston having a pump piston rod 25 extending from a top end thereof and pivotally connecting with an actuation lever 27 which is pivotally connected to the cylinder 18.

As the lever 27 is lowered, fluid is forced by the pump 24 from a lower end of the cylinder 18 through passages (not shown) within the cylinder to the upper end thereof, thereby extending the lift piston rod 20, and separating the upper end 16 of the support arm 7 from the lower end 11 of the lift arm 6 and causing the upper end 9 of the lift arm 6 to rise. As the lever 27 is raised, more fluid is drawn into the pump cylinder 24 from the lower end of the lift cylinder 18. The contact pad 1 is raised along with the upper end 9 of the lift arm 6 to thereby lift a member of a vehicle engaged by the contact pad 1. The pad 1 is lowered by operation of a release valve operator 29 which opens a valve (not shown) within the lift cylinder 18 to allow fluid to be returned to the lower end of the cylinder through a restriction, to thereby slow and control the lowering of the pad 1 and any load engaged thereby. Further details of a jack similar to the jack 2 can be found in U.S. Pat. No. 3,780,987. While the contact pad structure 1 is described in association with the jack 2 having the configuration described and illustrated, use of the contact pad structure 1 is not intended to be restricted to use with such a jack or lift device configuration.

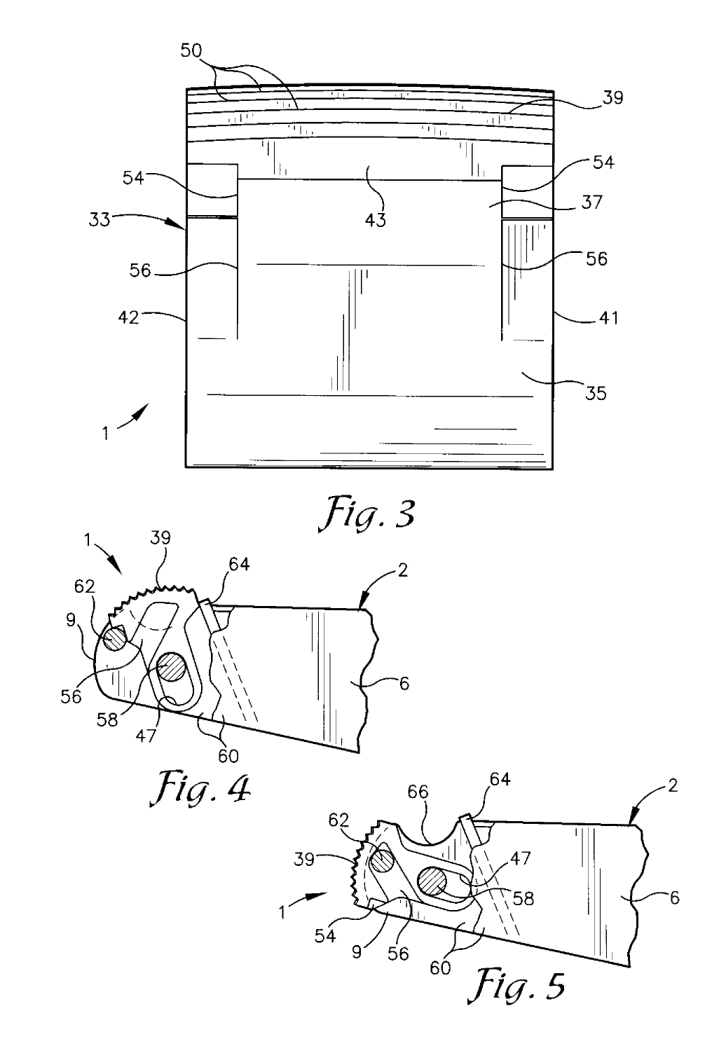

Referring to FIGS. 2 and 3, an embodiment of the compound curved contact pad structure 1 includes a contact pad body 33 formed by a mounting stem 35 which diverges into a wedge shaped contact head 37 having a contact surface 39 thereon. The pad structure 1 has opposite side surfaces 41 and 42, and the contact head 37 has a front surface 43 and a rear surface 44. The mounting stem 35 has a mounting bore 47 formed therethrough. The illustrated mounting bore 47 has an obround cross sectional shape, that is, the cross section is oblong and has rounded ends. The obround bore 47 functions in the manner of a slot, allowing the pad structure 1 to move along the major axis of the bore 47.

The contact surface 39 has a convex front-to-back curvature from the front surface 43 to the rear surface 44 which, in the illustrated structure 1, is substantially circular in cross section. The contact surface 39 additionally has a convex transverse curvature from side surface 41 to side surface 42 which is substantially circular in cross section. The contact surface 39, thus, has a compound convex curvature which is non-spherical in the illustrated contact pad structure 1. The front-to back curvature of the illustrated contact surface 39 has a radius of about 1.5 to 1.6 inches (3.81 to 4.06 cm), while the transverse curvature has a radius of about 18 inches (45.72 cm). The front-to-back curvature of the contact surface 39 allows the pad 1 to “roll” beneath the surface of the engaged vehicle member as the lift arm 6 of jack 2 is raised, thereby maintaining positive, non-slip contact with the vehicle member. The lateral or transverse curvature of the contact surface 39, on the other hand, accommodates a degree of angular disparity between the contact pad 1 and the engaged vehicle member, while maintaining positive contact therewith and without gouging or marring the surface of the engaged member by engagement of an edge of the pad 1 therewith.

The compound curved contact surface 39 has a non-slip surface texture to provide more positive and safer engagement of the contact pad structure 1 with a member of a vehicle to be lifted. The illustrated structure 1 has a plurality of elongated serrations or V-shaped ridges 50 extending transversely from side surface 41 to side surface 42 substantially parallel to the front and rear surfaces 43 and 44. Alternatively, the serrations 50 could extend in a V-shaped manner or a curved manner instead of the linear manner illustrated. The illustrated serrations 50 cover the contact surface 39 from the front surface 43 to the rear surface 44. While the illustrated contact surface 39 is formed integrally with the contact head 37, it is foreseen that the contact surface 39 could be part of a replaceable cap, diagrammatically indicated by the broken line 45 in FIG. 2, which is joined to the contact head 37, such as by recessed fasteners (not shown). Such a cap could be metallic or another material, such as a rubber or plastic, having mechanical frictional properties and non-slip surface configurations. It also is foreseen that the contact surface 39 could be provided with non-slip properties by alternative configurations, such as by knurling, checkering, scoring, or the like. And while the illustrated serrations 50 are substantially V-shaped in cross section, they could alternatively be saw-toothed, square-toothed, crenelated, scalloped, or the like in cross section.

On the illustrated jack 2, the contact pad structure 1 is capable of being placed in one of two positions, a deployed position (FIG. 4) or a stowed position (FIG. 5). For this purpose, the pad structure 1 is provided with a pair of deployed position or deployment notches 54 formed at the intersection of the side surfaces 41 and 42 with the front surface 43 on opposite sides of the contact pad body 33 and elongated stowed position or stowing notches 56 formed in the side surfaces 41 and 42. The contact pad structure 1 is mounted on the lift arm 6 of the jack 2 by passage of a mounting pin 58 through the obround bore 47. The mounting pin 58 extends between the transversely spaced side members 60 of the lift arm 6. The sets of notches 54 and 56 engage short pegs 62 extending internally from the side members 60. In order to place the contact pad 1 in the deployed position, the pad 1 is pivoted upwardly about the mounting pin 58 and lifted somewhat to disengage the stowing notches 56 from the pegs 62 until it engages a cross wall 64. The pad 1 is then lowered to engage the deployed notches 54 with the pegs 62. In the deployed position, the contact surface 39 of the pad 1 is positioned upwardly to engage a member of the vehicle to be lifted. To place the pad in the stowed position, the pad 1 is lifted to disengage the deployed notches 54 from the pegs 62, then pivoted forwardly and downwardly to engage the stowed notches 56 with the pegs 62. The lift arm 6 is provided with a pair of lift notches 66 formed in upper edges of the side members 60. The lift notches 66 may be used for engagement with tubular or cylindrical members of the vehicle to be lifted, and other shaped members. The stowed position of the contact pad 1 provides access to the lift notches 66.

It is to be understood that while certain forms of the present invention have been illustrated and described herein, it is not to be limited to the specific forms or arrangement of parts described and shown.

What is claimed and desired to be secured by Letters Patent is:

1. A curved contact pad for engagement with an object to be lifted by a lift device and comprising:
(a) a contact pad body having opposite, transversely spaced pad sides and a contact surface extending in a transverse direction between said pad sides, said contact pad including a pad connection portion to enable connection of the contact pad body to a lift device;
(b) said contact surface having a non-slip surface texture formed thereon; and
(c) said contact surface having a convex curvature from one of said pad sides to an opposite one of said pad sides.

2. A pad as set forth in claim 1 wherein:
(a) said pad includes a separable contact pad cap having said contact surface thereon; and
(b) said non-slip surface texture is formed on said contact surface of said cap.

3. A pad as set forth in claim 1 wherein:
(a) said contact surface has a compound convex curvature.

4. A pad as set forth in claim 1 wherein:
(a) said contact surface additionally has a convex curvature in a direction substantially perpendicular to said transverse direction.

5. A pad as set forth in claim 1 wherein:
(a) said non-slip surface texture includes a plurality of elongated serrations extending in said transverse direction of said contact surface.

6. A pad as set forth in claim 1 wherein:
(a) said non-slip surface texture includes a plurality of elongated serrations extending in said transverse direction of said contact surface between said pad sides.

7. A pad as set forth in claim 1 wherein:
(a) said pad body includes a deployment formation to enable said pad body to be selectively positioned in a deployed position with respect to said lift device for engagement of said contact surface with an object to be lifted or a stowed position with respect to said lift device.

8. A compound curved contact pad for engagement with an object to be lifted by a lift device and comprising:
(a) a contact pad body formed by a mounting stem terminating in a contact head, said mounting stem being adapted to enable connection to a lift device;
(b) said contact pad body having opposite, transversely spaced side surfaces and said contact head having a front edge surface and a rear edge surface;
(c) said contact head having a contact surface extending between said side surfaces and said edge surfaces;
(d) said contact surface having a compound convex curvature; and
(e) said contact surface having a non-slip surface texture formed thereon.

9. A pad as set forth in claim 8 wherein:
(a) said pad includes a separable contact pad cap having said contact surface thereon; and
(b) said non-slip surface texture is formed on said contact surface of said cap.

10. A pad as set forth in claim 8 wherein:
(a) said non-slip surface texture includes a plurality of elongated serrations extending transversely between said side surfaces on said contact surface.

11. A pad as set forth in claim 8 wherein:
(a) said non-slip surface texture includes a plurality of elongated serrations extending transversely between said side surfaces on said contact surface from said front edge to said rear edge.

12. A pad as set forth in claim 8 wherein:
(a) said mounting stem includes a mounting bore formed therethrough to enable connection of said contact pad to said lift device.

13. A pad as set forth in claim 8 wherein:
(a) said pad body includes deployment formations to enable said pad body to be selectively positioned in a deployed position with respect to said lift device for engagement of said contact surface with an object to be lifted or a stowed position with respect to said lift device.

14. A pad as set forth in claim 8 and including:
(a) a set of notches formed into said side surfaces of said pad to engage structure on said contact pad to thereby enable said pad body to be selectively positioned in a deployed position with respect to said lift device for engagement of said contact surface with an object to be lifted or a stowed position with respect to said lift device.

15. A pad as set forth in claim 8 and including:
(a) a mounting bore formed through said pad body, said bore having an obround cross section;
(b) a pair of deployment notches formed respectively into said side surfaces;
(c) a pair of stowing notches formed respectively into said side surfaces; and
(d) said bore and said pairs of notches cooperating with structure on said lift device to thereby enable said pad body to be selectively positioned in a deployed position with respect to said lift device for engagement of said contact surface with an object to be lifted or a stowed position with respect to said lift device.

16. A compound curved contact pad for engagement with an object to be lifted by a lift device and comprising:
(a) a contact pad body formed by a mounting stem terminating in a contact head;
(b) said mounting stem includes a mounting bore formed therethrough to enable connection of said contact pad to said lift device;
(c) said contact pad body having opposite, transversely spaced side surfaces and said contact head having a front edge surface and a rear edge surface;
(d) said contact head having a contact surface extending between said side surfaces and said edge surfaces;
(e) said contact surface having a compound convex curvature;
(f) said contact surface having a plurality of elongated serrations extending transversely between said side surfaces on said contact surface from said front edge to said rear edge; and
(g) said pad body includes deployment formations to enable said pad body to be selectively positioned in a deployed position with respect to said lift device for engagement of said contact surface with an object to be lifted or a stowed position with respect to said lift device.

17. A pad as set forth in claim 16 and including:
(a) said mounting bore having an obround cross section;
(b) a pair of deployment notches formed respectively into said side surfaces;
(c) a pair of stowing notches formed respectively into said side surfaces; and
(d) said bore and said pairs of notches cooperating with structure on said lift device to thereby enable said pad body to be selectively positioned in a deployed position with respect to said lift device for engagement of said contact surface with an object to be lifted or a stowed position with respect to said lift device.
